(19) United States
(12) Patent Application Publication
(10) Pub. No.: US 2014/0146854 A1
(43) Pub. Date: May 29, 2014

(54) TEMPERATURE CALIBRATION AND CONTROL FOR SEMICONDUCTOR REACTORS

(71) Applicant: Solexel, Inc., (US)

(72) Inventors: Jay Ashjaee, Cupertino, CA (US); Karl-Josef Kramer, San Jose, CA (US); Mehrdad M. Moslehi, Los Altos, CA (US)

(73) Assignee: Solexel, Inc., Milpitas, CA (US)

(21) Appl. No.: 13/866,990

(22) Filed: Apr. 19, 2013

Related U.S. Application Data
(60) Provisional application No. 61/635,824, filed on Apr. 19, 2012.

(51) Int. Cl. G01K 7/02

(52) U.S. Cl. CPC G01K 7/02
USPC 374/179

(57) ABSTRACT

Non-contact and non-invasive temperature measurement structures and methods for thermal processing systems which neither damage nor contaminate the thermal processing environment are provided.

### CROSS-REFERENCE TO RELATED APPLICATIONS

This application claims priority to U.S. Provisional Patent Application Ser. No. 61/635,824 filed Apr. 19, 2012, which is hereby incorporated by reference in its entirety.

### FIELD

The present disclosure relates in general to the fields of semiconductor processing. More particularly, the present disclosure relates to the methods, architectures, and apparatus related to temperature calibration and control of semiconductor reactors.

### BACKGROUND

In thermal processing systems, direct workpiece measurement is challenging as temperature measurement instruments, such as thermocouples, often are unable to attach to the workpieces, or workpiece carriers, directly and particularly during processing conditions. Typically, in such cases non-contacting temperature measurement techniques are used, such as pyrometry or phosphor thermometry and alike, or temperatures are determined based on indirect measurements, such as input power. However, such techniques require regular in-situ calibrations under thermal and ambient (gas type and flow) conditions similar to actual semiconductor processing conditions—which often require a contacting measurement device. Thermocouples are often used for this calibration, particularly at high temperatures above 600 degrees C.

In epitaxial processing equipment, the direct attachment of thermocouples to susceptors is often impractical and faces significant technical issues if the wafers are positioned in non-stationary susceptors. In instances when direct workpiece (or container) temperature measurement during processing is not possible or impractical, such as when the workpiece (or container) is not stationary, then the workpiece temperature is commonly deduced from another reference temperature measurement or from input heating power. However, the relationship between actual temperature and the input power or the reference measurement must be determined through system calibration using some form of direct temperature measurement under conditions similar to the real processing conditions. And as this relationship may drift with time and processing cycles, for example, due to changing conditions or aging, it often becomes necessary to recalibrate. Thus, in high volume manufacturing it is important to have a calibration scheme that may be carried out as quickly as possible to reduce and minimize calibration time during which the machine is not in use for actual production.

In thermal processing systems, and particularly those operating at high temperatures, it is often not possible to measure the temperature of the process as the process is being carried out because the presence of temperature measurement devices would negatively influence the outcome of the thermal process. This influence may be exacerbated for high temperature processes in semiconductor or photovoltaic processing, for example in deposition systems where the permanent presence of temperature monitoring devices (such as thermocouples or precision resistors) is not compatible with the process chemistry used and metal emanating from the temperature monitoring devices would negatively affect the quality of the deposited material or the substrates that material is deposited on. Additional complications may occur when the thermal processing systems are in-situ cleaned which may be highly desirable for the uptime and ease of maintenance of such systems but which also creates additional challenges as the cleaning chemistry often attacks the measurement devices.

Further, direct contact between thermocouples and susceptors may introduce contamination to the susceptors and degrade the quality of the resulting epitaxial semiconductor films. As a result, special susceptors with imbedded thermocouples are used for temperature calibration, but swapping such susceptors after use is time-consuming and undesirable in high volume manufacturing, particularly for multi-chamber systems. Additionally, the hollowing of susceptors for thermocouple insertion in conjunction with the presence of such thermocouples often introduces unacceptable measurement errors within the reactor under transient conditions.

### BRIEF SUMMARY

Therefore, a need has arisen for temperature calibration and control of thermal processing systems. In accordance with the disclosed subject matter, methods and structures for the non-invasive temperature calibration and in process temperature control of thermal processing systems are provided which substantially eliminate or reduce the cost and fabrication disadvantages associated with previously developed thermal processing systems temperature measurement methods.

According to one aspect of the disclosed subject matter, thermal processing systems and a non-contact and non-invasive temperature measurement assembly which neither damages nor contaminates the process environment is provided. The thermal processing system comprises a chamber housing a pair of susceptors positioned in a face to face arrangement. Each susceptor supporting at least one work piece and forming a processing cavity between the wafers. A thermocouple assembly comprising an encapsulation rod housing at least one thermocouple is positioned to measure the susceptor temperature of the susceptor surface proximate the processing cavity.

These and other aspects of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following FIGUREs and detailed description. It is intended that all such additional systems, methods, features and advantages that are included within this description, be within the scope of any claims.

### BRIEF DESCRIPTION OF THE DRAWINGS

The features, nature, and advantages of the disclosed subject matter may become more apparent from the detailed description set forth below when taken in conjunction with the drawings in which like reference numerals indicate like features and wherein:

FIGS. 1A and 1B are cross-sectional diagrams showing an epitaxial deposition system embodiment having workpieces positioned in susceptors arranged in a face to face design and enclosed within a reactor cavity;

FIGS. 2A and 2B are cross-sectional diagrams showing an epitaxial deposition system embodiment comprising non-contact and non-invasive thermocouple assembly;

FIG. 3A is a cross-sectional diagram of the multi-chamber thermocouple assembly;

FIG. 3B is a cross-sectional diagram showing a thermocouple array extending bi-directionally;

FIGS. 4A and 4B are diagrams of a reactor assembly with encapsulated thermocouple rods arranged alongside and in proximity to the susceptor-assembly;

FIGS. 5A and 5B are diagrams of a reactor assembly having encapsulated thermocouple rods arranged alongside and enclosed by susceptors;

FIGS. 6A and 6B are diagrams of a reactor assembly having encapsulated thermocouple rods enclosed by the susceptor pair and positioned in the deposition zone; and

FIG. 7 is a general process flow showing a non-invasive high throughput temperature calibration method.

### DETAILED DESCRIPTION

The following description is not to be taken in a limiting sense, but is made for the purpose of describing the general principles of the present disclosure. The scope of the present disclosure should be determined with reference to the claims. Exemplary embodiments of the present disclosure are illustrated in the drawings, like numbers being used to refer to like and corresponding parts of the various drawings.

And although the present disclosure is described with reference to specific embodiments, such as chemical vapor deposition (for example epitaxial deposition) processing using a lamp heated thermal reactor, one skilled in the art could apply the principles discussed herein to other materials, technical areas, and/or embodiments without undue experimentation. For example, the temperature calibration methods provided herein may be applicable to any thermal wafer processing (such as annealing) in a reactor providing a uniform thermal environment heated by, for example, lamp heating, inductive heating or resistive heating.

The disclosed subject matter provides non-contact and non-invasive temperature measurement for thermal processing systems which neither damage nor contaminate the process environment or susceptors. Further, the disclosed calibration structures and methods may be carried out quickly and integrated with a material handling system of the processing equipment for automated in-situ calibration and high volume manufacturing. And, in some embodiments, direct temperature measurement during thermal processing may be performed without contacting susceptors.

In operation, the disclosed subject matter is applicable to any thermal processing system wherein workpieces are placed inside enclosed containers that may be heated. The following methods and tools for non-invasive and fast temperature calibration are described with reference to thermal processing equipment wherein the workpieces are confined within a cavity of substantially unidirectionally uniform temperature chamber. In one embodiment, this application is in a semiconductor deposition system in which semiconductor wafers are placed into carriers, commonly called susceptors, positioned in a face-to-face arrangement inside processing chambers—an application particularly relevant for the epitaxial deposition of crystalline materials such as crystalline silicon. Such systems may also be used for deposition of non-crystalline material layers as well as other processing applications such as thermal annealing, oxidation, and/or nitridation of semiconductor wafers. The chamber cavity and workpieces (wafers) positioned therein may be heated using lamps, or commonly known inductive and resistive heating methods and structures. And in some embodiments, the direct temperature measurement may be obtained during processing using non-invasive devices positioned proximate the thermal processing.

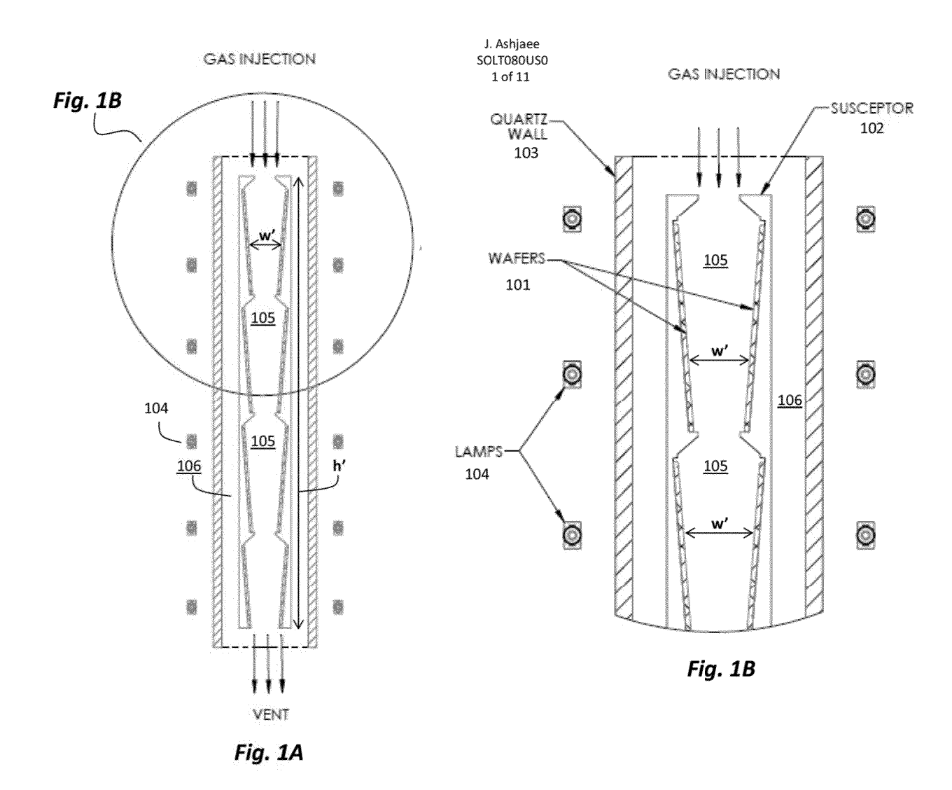

FIG. 1A is a cross-sectional diagram showing an epitaxial deposition system embodiment having workpieces positioned in susceptors arranged in a face to face design and enclosed within a reactor cavity. FIG. 1B is an expanded view of a portion of FIG. 1A. The system shown may result in considerably uniform-temperature susceptor surfaces during processing. example of such an epitaxial reactor is shown schematically in FIG. 1. Further, the epitaxial deposition reactor of FIG. 1, and related non-invasive temperature measurement methods disclosed herein, may be used for a number of applications such as semiconductor wafer processing and solar cell substrate deposition and processing. In the epitaxial deposition reactor of FIG. 1, wafers 101 are placed onto susceptors 102 which may comprise two separate (or multiple) pieces but form substantially confined cavity 105 when mated together. The susceptor design shown is a face to face arrangement providing a enclosed cavity with a uniform (or negligible for processing purposes) temperature distribution across the cavity formed by two facing susceptors, shown as cavity width w′ in FIG. 1B (which may also vary/taper in the gas flow direction for deposition purposes). Cavity 105 formed within the susceptors may be a narrow passage, for example with a width (w′) in the range of approximately 1 to 10 cm, and relatively long and/or deep (show as h′ and for example up to a meter or longer) to allow for the arrangement of more wafers and larger batch sizes. The loading of the wafers onto susceptors may be manual or by robotic handling means for high volume manufacturing. After loading of the wafers onto susceptors and mating the corresponding facing susceptor pieces together to form a cavity, each assembly of susceptors 102 may then be transported and placed inside a processing chamber defined by walls 103. Susceptors 102 are then heated, for example by lamps 104 as shown in FIG. 1. In some instances, such as that described, chamber walls 103 are substantially transparent to the emitted radiation from the lamps and may be made of materials such as quartz, for example. Additionally, the susceptors may be made of materials such as silicon carbide coated graphite or polysilicon, for example.

Next, in the case of epitaxial growth, deposition gases are injected into cavity space 105 between the susceptors from one direction (from the top as shown in FIG. 1), and vented from the opposite side. Importantly, the flow may be reversed during a portion of the epitaxial growth process to improve thickness uniformity (and doping uniformity for doped layers) of the deposited layer. For silicon epitaxy for example, injected gases may be gasses such as silicon tetrachloride (STC), silane, dichlorosilane (DCS), or trichlorosilane (TCS) in combination with hydrogen. Further, a gas, such as hydrogen, may be flowed in the cavity space between susceptors 102 and the walls 103, shown as cavity 106 in FIG. 1, to prevent or substantially reduce deposition outside of cavity 105. For in-situ cleaning of the reactor and susceptors, a gas such as hydrogen chloride (HCl) may be used.

The epitaxial deposition above may require temperature calibration both between deposition processes and during (in-situ) deposition for the controlled and uniform deposition of a semiconductor layer. However, attaching thermocouples to the susceptors for temperature calibration may be challenging as the susceptors are not stationary (for example, they may be loaded into and unloaded from the quartz chambers along with the semiconductor wafers). Further, positioning/attaching thermocouples to susceptors by drilling thermocouple holes into the susceptors may create challenges such as, for example: the susceptors may be too thin and mechanically weak to support the formation of long thermocouple holes while increasing susceptor thickness may increase heating and cooling times thus increasing processing time and decreases throughput. Further, increasing susceptor wall thickness may also increase the amount of energy required to heat the susceptors to a desired deposition temperature thus decreasing volume production. Additionally, thermocouple holes in the susceptors may be exposed to deposition and cleaning processing further affecting deposition. And if susceptors with corresponding thermocouple holes are limited to temperature calibration and not used during deposition, then swapping susceptors (from temperature calibration susceptors with corresponding attached thermocouples to processing susceptors without corresponding thermocouples) may increase calibration time and tool cost and result in increased susceptor management in an automated tool.

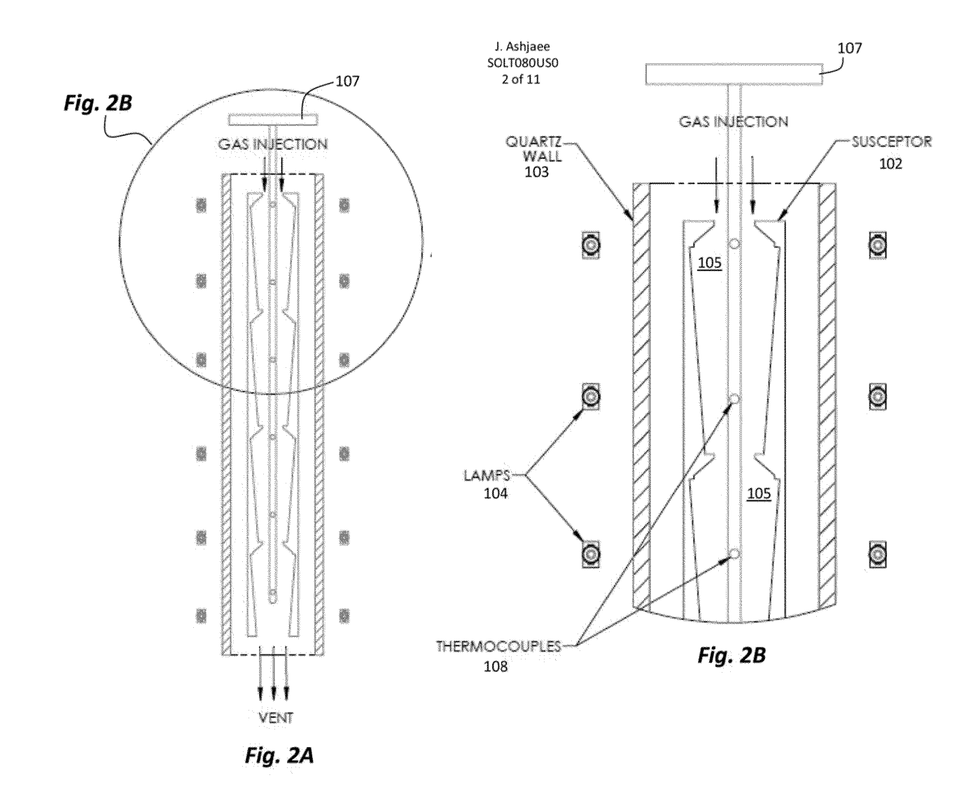

The disclosed thermocouple designs and corresponding chamber structures provide in-situ temperature calibration without the need to use special calibration susceptors. FIG. 2A is a cross-sectional diagram showing an epitaxial deposition system embodiment similar to that shown in FIG. 1A and further comprising non-contact and non-invasive thermocouple assembly 107 comprising rods housing thermocouples 108. FIG. 2B is an expanded view of a portion of FIG. 2A. As shown in FIG. 2, thermocouple assembly 107 is inserted in cavity space 105 between susceptors 102 during calibration and positioned without touching the susceptors and interfering with or contaminating the susceptors or chamber. The thermocouple assembly is positioned in the thermal processing system and is substantially enclosed in the processing cavity (105) such that in thermal equilibrium the thermocouple temperature closely reflects the susceptor temperature without touching the susceptors. Thermocouple assembly 106 may comprise at least one and often a plurality of thermocouples, shown as thermocouples 108. The susceptor walls form a substantially enclosed cavity and the measurements obtained by thermocouples along the length of the cavity (h′) represent internal susceptor temperatures when the susceptors are reasonably uniform in temperature for ranges between approximately 300 to 1200 deg C. In this method, the deviations from the desired process temperature may be measured and corrected and non-uniformity in wall temperatures may also be deduced from the measurements at different thermocouple locations. In other words, by positioning the thermocouples between and substantially enclosed by the susceptors, in thermal equilibrium the thermocouple temperature closely reflects susceptor temperature with the need to contact/touch the susceptor.

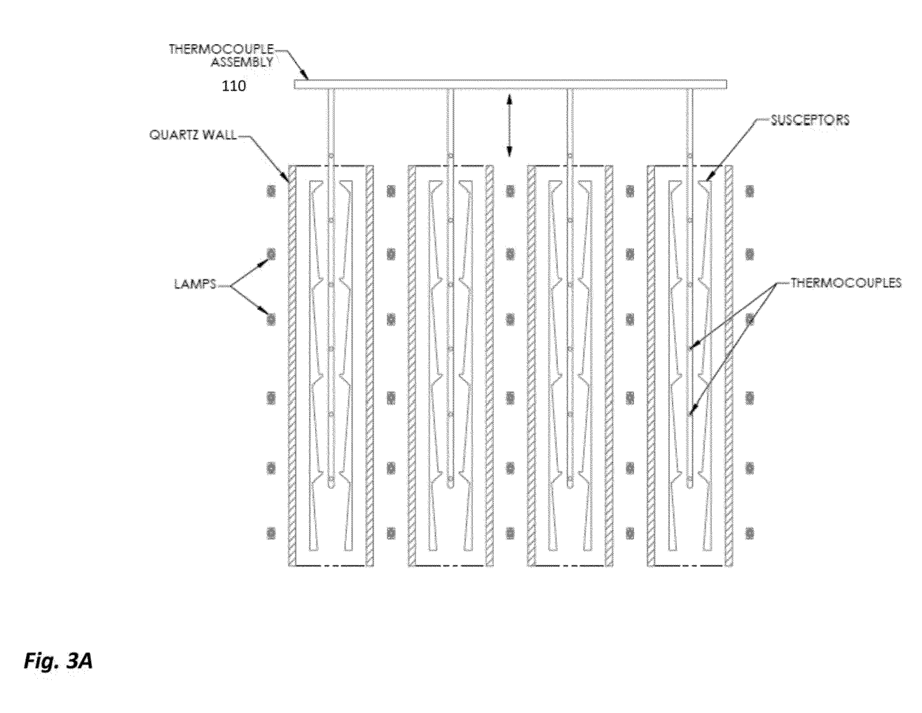

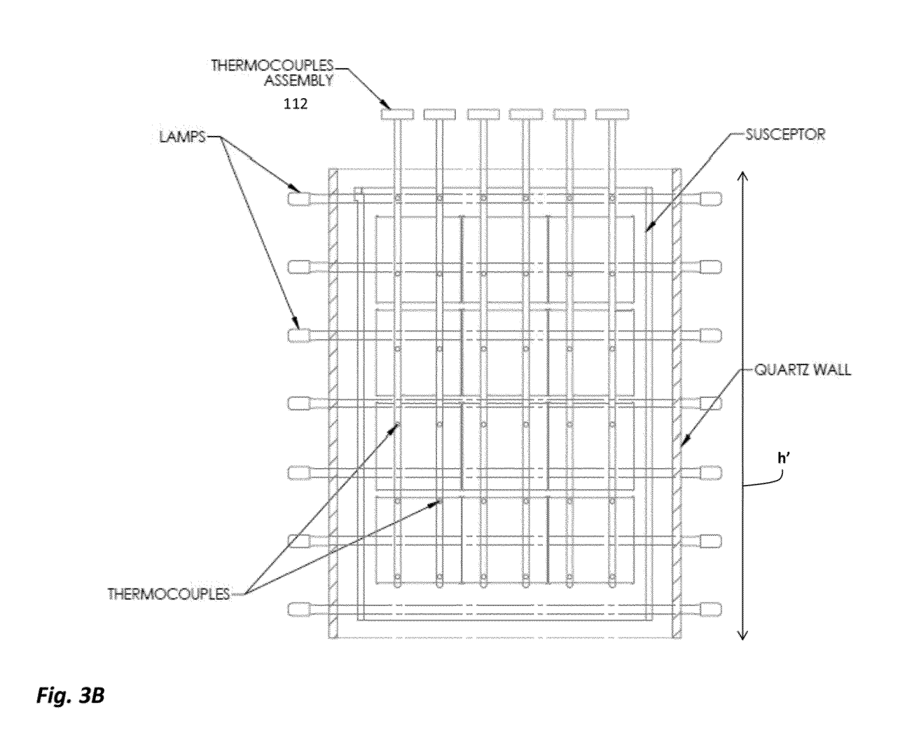

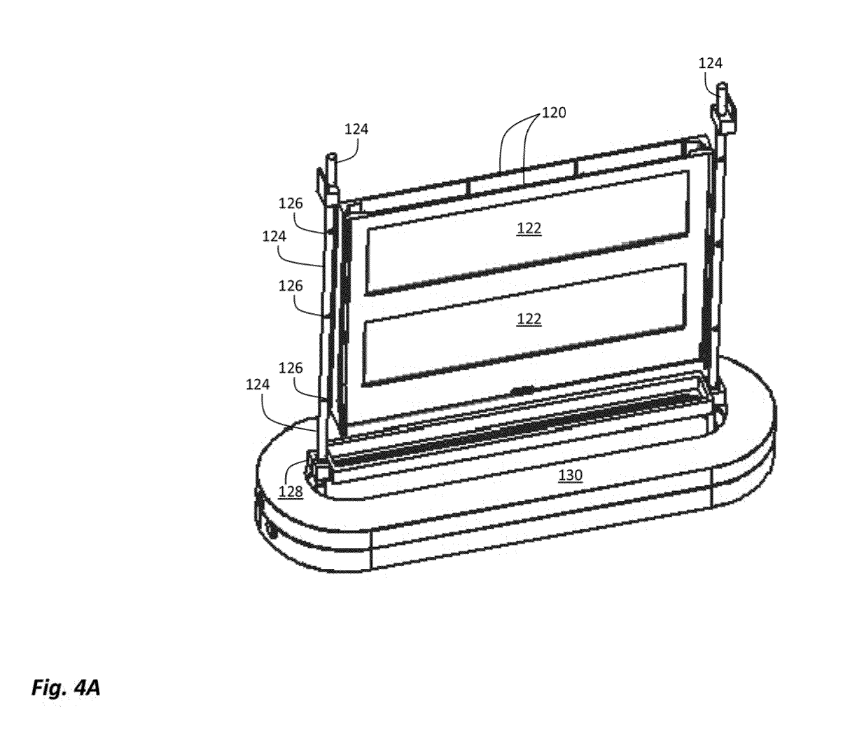

Furthermore, the thermocouple assembly may be integrated with moving mechanisms processing equipment within a single or multi-chamber deposition system for automated in-situ calibration, shown schematically by cross-sectional diagram of the multi-chamber thermocouple assembly 110 in FIG. 3A.

The disclosed thermocouple assembly structures also provide for bi-directional susceptor cavity temperature mapping—in other words, temperature mapping of the epitaxial deposition systems shown in FIGS. 1A and 2A along the z-axis. FIG. 3B is a cross-sectional diagram of the epitaxial deposition systems shown in FIGS. 1A and 2A rotated 180 degrees and showing thermocouple assembly 112 having a plurality of rods housing thermocouples extending bi-directionally. In other words, the diagram of FIG. 3B is a view of cavity 105 through susceptor 102. Thus, a two-dimensional mapping of the susceptor temperature may be quickly obtained by deploying multiple non-contacting thermocouple assemblies within each chamber. Further, the internal wall measurement obtained accurately represents the real processing conditions, particularly when the magnitude of temperature gradient across the susceptor wall is large—in other words, in the case of a large temperature difference between the inside susceptor wall proximate the internal cavity 105 and the outside of the susceptor wall proximate outer cavity 106.

The disclosed temperature calibration systems and methods provide fast temperature calibration for high-volume manufacturing which in some instances may be further integrated with epitaxial processing equipment for automated in-situ calibration and measurement. In some instances, this may include the permanent incorporation of thermocouples inside high temperature processing equipment with mobile susceptors (for example epitaxial deposition reactors).

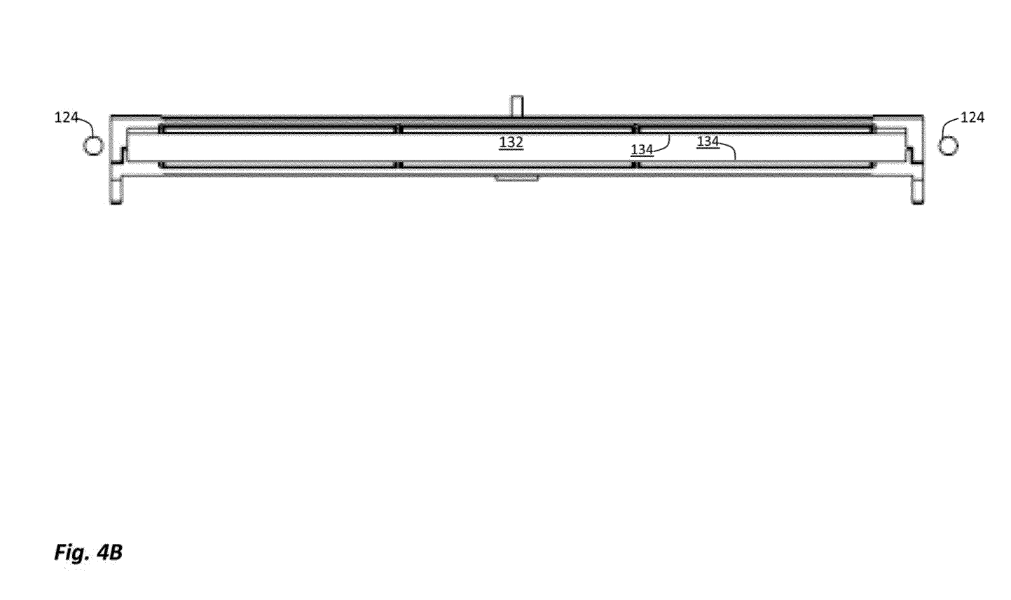

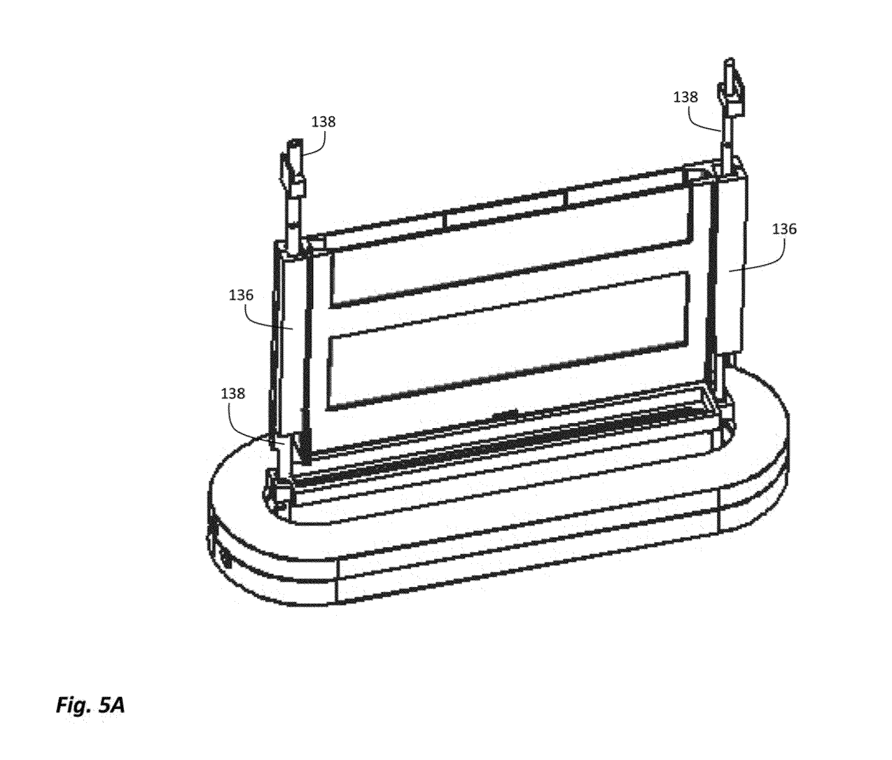

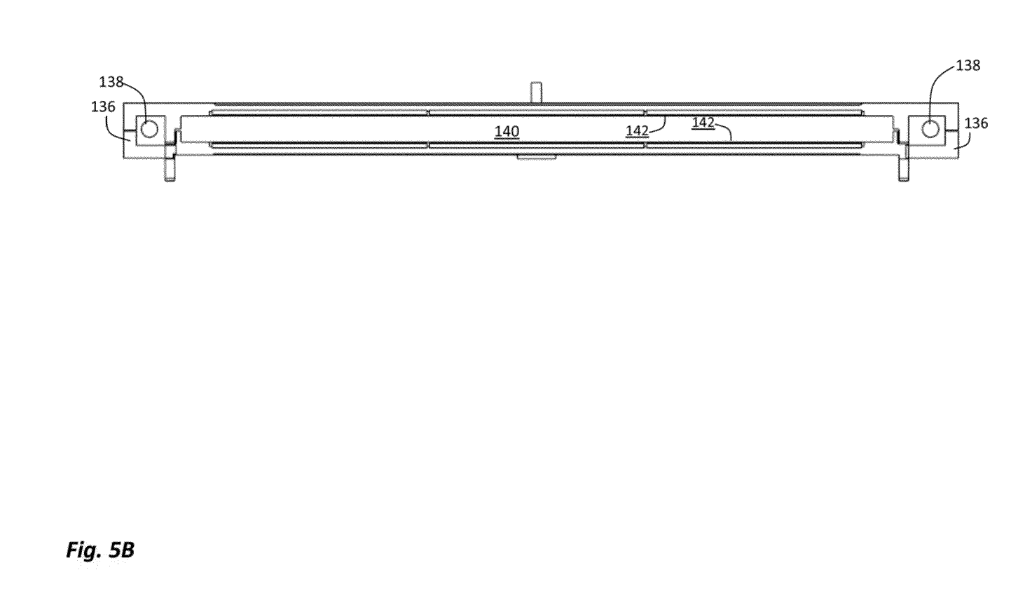

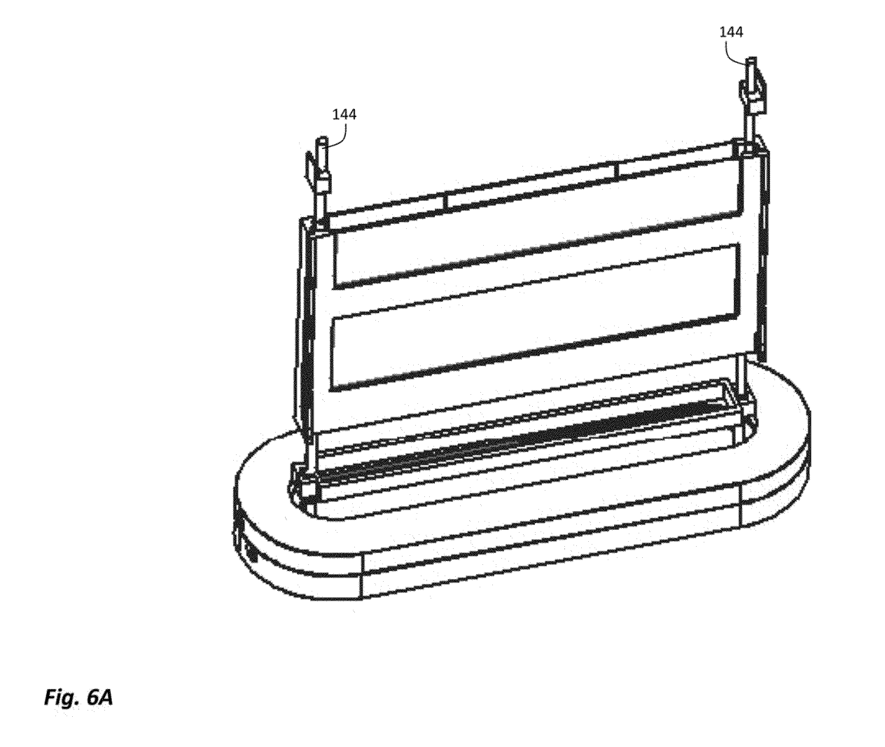

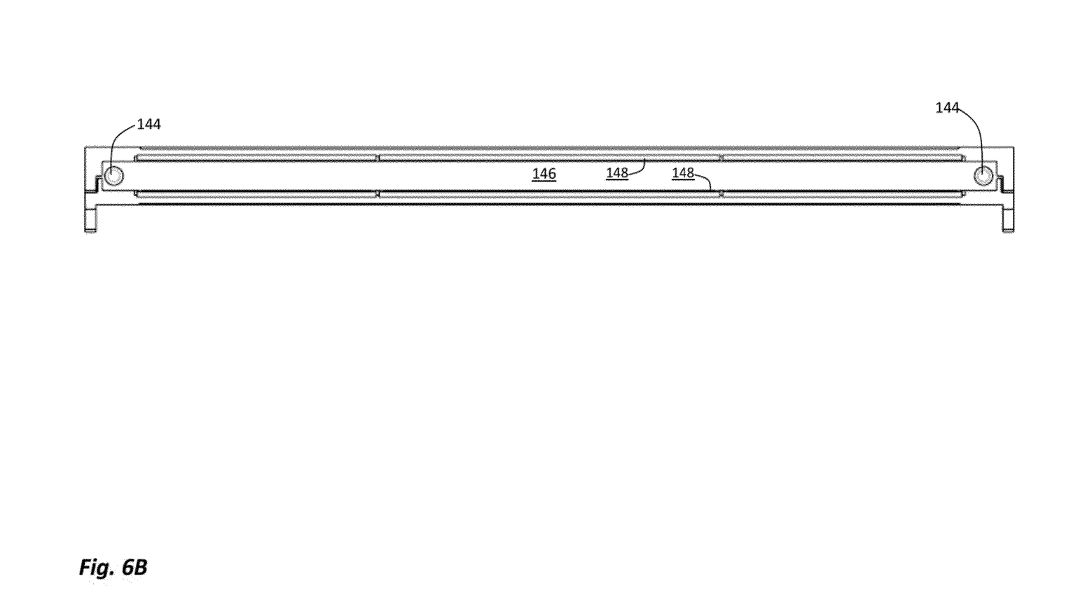

Often it is difficult to incorporate thermocouples in high temperature reactors, such as those described above, for a number of reasons including the risk of exposure to potentially corrosive gases and contamination of the susceptors and the deposition process by the thermocouples and their leads. Other problems incorporating thermocouples in high temperature reactors include challenges avoiding or managing depositions on thermocouples and thermocouple holders during processing. The present disclosure presents solutions to such problems utilizing structure designs such as encapsulation, locations, and mounting of thermocouples and feedthroughs, as well as through the utilization of different reactor zones or regions containing different temperatures and gasses. In the latter case, the thermocouples may be positioned either in a zone that does not receive deposition gas, but only purge gas such as hydrogen, or the thermocouple may be exposed to the same deposition and etching gases as required for processing. The thermocouples are enclosed within the same, approximately isothermal susceptor that encloses the workpieces/wafers and housed in materials similar to those of the susceptor. Generally, thermocouple assembly epitaxial deposition incorporation is described with reference to the following embodiments: thermocouple assembly positioned outside process area and outside the susceptor (FIG. 4); thermocouple assembly positioned inside the process area and outside the susceptor (FIG. 5); and the thermocouple assembly positioned inside the process area and inside the susceptor (FIG. 6).

To minimize the effect of the thermocouple assembly during processing, the thermocouple assembly comprising rods housing the thermocouples may be made of the same or similar materials to that of the susceptors. For example, in some instances, the heated reactor may comprise materials such as quartz chamber walls and silicon carbide, silicon, or silicon carbide coated graphite based susceptors (for instance such susceptors made from isostatically pressed graphite as well as from carbon composite materials) and may further comprise a thermocouple or a set of thermocouples enclosed and encapsulated in a rod made of susceptor like material and arranged alongside the susceptor or susceptors. Encapsulated temperature measurement spots may then be calibrated using above mentioned calibration thermocouple arrangements.

The thermocouple encapsulation material may be the same or similar to the susceptor material—thus, the same cleaning mechanisms (for example high temperature HCl gas etching of deposited silicon) may be employed to repeatedly strip deposit from the encapsulated thermocouple. Further, an electrical feedthrough and hole in the encapsulation may be positioned in an area not subject to corrosive gases or an area where corrosive gasses are present in highly dilute concentrations and temperatures are below the reaction threshold of the corrosive gases. In some instances, the feedthrough entry zones may also optionally be purged with gases such as hydrogen.

The diagrams of FIGS. 4, 5, and 6 show conceptually the arrangement of non-invasive and non-contact thermocouples in a top loaded reactor.

FIG. 4A is a diagram of a reactor assembly with encapsulated thermocouple rods arranged alongside and in proximity to the susceptor-assembly. FIG. 4B is a cross-section of the reactor assembly of FIG. 4A. The reactor assembly of FIG. 4A comprises a pair of susceptors 120 in a face to face arrangement (separated by a confined cavity), supported by lower flange plate 130, and having wafer pockets 122 to hold wafers for processing. Thermocouple encapsulation rod 124 are positioned alongside and in proximity to the susceptor assembly and houses thermocouple 126 positioned at predetermined temperature measurement spots to be used as temperature monitors. The electrical feedthrough 128 is positioned in a cold zone (away from corrosive gasses). The electrical feedthroughs may positioned at a lower flange plate, an arrangement particularly applicable if the susceptors themselves are handled automatically or manually into and out of the reactor chamber by means of a mobile upper flange plate (in other words, the susceptors are suspended by an upper flange plate). Susceptor support may be provided by quartz guides that accommodate for differential expansion of the encapsulation tube during the temperature cycles. In some instances, the quartz guides may be integrated with the stationary part of the chamber.

In some embodiments, the lower flange plate may be segmented, for example into an outer and an inner part such that a stationary outer part contains the permanent feedthroughs for the thermocouples and an easily detachable inner part allows for easy maintenance access to the inside of the flange. An arrangement advantageous for maintenance to a bottom flow nozzle or for retrieval of debris or lost wafers.

FIG. 4B is a cross-section of the reactor assembly of FIG. 4A showing thermocouple rods 124 and confined gas flow channel 132 (similar to cavity 105 in FIGS. 1 and 2) which acts as the main reaction zone for facing wafers 134 supported by face to face susceptors. In the thermocouple assembly arrangement of FIG. 4, the thermocouples are arranged outside of the susceptors and do not measure the same temperature as the susceptor. However, the thermocouples may be used to monitor variations in temperature within a process run and from process run to process run.

In some instances, the thermocouple arrangements shown FIGS. 5 and 6 may allow for a closer representation of the temperature in the active deposition zone of the reactor as compared to the embodiment shown FIG. 4. FIG. 5A is a diagram of a reactor assembly similar to that of FIG. 4A except having encapsulated thermocouple rods arranged alongside and are enclosed by the susceptors. Thermocouple rods are enclosed by the susceptor pair but are separated from the main deposition zone. FIG. 5B is a cross-section of the reactor assembly of FIG. 5A. Thermocouple encapsulation rod holders/guides 138 are positioned alongside and in proximity to and enclosed by the susceptor assembly, shown as thermocouple encapsulation 136 which may be a monolithic with the susceptor pair body. In other words, thermocouple encapsulation 136 which houses thermocouple encapsulation rod 138 is a part of the susceptor itself, as shown in FIG. 5B. Thermocouple encapsulation rod holders/guides 138 houses thermocouples positioned at predetermined temperature measurement spots (which may be arranged such as those shown in FIG. 4A) to provide susceptor temperature measurement. In one embodiment, the top guides may be part of an upper flange (not shown) such that the rods are fed into the guides as the susceptors and the upper flange are lowered to position the susceptors into the reactor chamber. Feedthrough contacts are positioned at the bottom of the chamber.

FIG. 5B is a cross-section of the reactor assembly of FIG. 5A showing thermocouple rods 138 housed in thermocouple encapsulation 136 and confined gas flow channel 140 (similar to cavity 105 in FIGS. 1 and 2) which acts as the main reaction zone for facing wafers 142 supported by face-to-face susceptors. In the thermocouple assembly arrangement of FIG. 5, the thermocouples are arranged alongside and on the inside of the susceptor, but separated from the main reaction zone, to measure and control susceptor temperature during processing. An advantage of this thermocouple arrangement is that the thermocouples are not directly exposed to deposition process gasses as the channels that house the thermocouples may contain a purge gas, such as hydrogen. However, the thermocouples are still enclosed to a large extent by the radiating—idealized—black body of the susceptor, and therefore the temperature measured is a representation of the actual reaction temperature at the susceptor/wafer surface.

FIG. 6A is a diagram of a reactor assembly similar to that of FIG. 5A except having encapsulated thermocouple rods enclosed by the susceptor pair and positioned in the deposition zone. Thermocouple rods 144 are enclosed by the susceptor pair and positioned in the main deposition zone. Feedthrough contacts are positioned at the bottom of the chamber. FIG. 6B is a cross-section of the reactor assembly of FIG. 6A showing thermocouple rods 144 housed within the main reaction zone/gas flow channel 146 (similar to cavity 105 in FIGS. 1 and 2) which acts as the main reaction zone for facing wafers 148 supported by face to face susceptors. In the thermocouple assembly arrangement of FIG. 6, the thermocouples are arranged in the main reaction zone to measure and control susceptor temperature during processing. An advantage of this thermocouple arrangement is that from a temperature measurement point of view, the measurement points are inside the very same—idealized—black body of radiation the reaction takes place in so the temperature measured is a close representation of the actual reaction temperature at the susceptor or wafer surface.

In the embodiments shown in FIGS. 5 and 6, the encapsulated non-invasive and non-contact thermocouples are positioned as stationary thermocouples in proximity and within the two halves of a susceptor pair. In such an arrangement, the measured thermal environment is close to the environment of the work pieces/wafers (for example silicon substrates) which yields highly accurate temperature measurements. In the embodiment shown in FIG. 5 the encapsulated thermocouple rods are enclosed by the susceptor pair but separated from the main process gas flow area, whereas in embodiment shown in FIG. 6 the encapsulated thermocouple rods are exposed to the main process gas flow. In some cases, and in the latter case particularly, it may be important that the thermocouple encapsulation rods are designed and made of materials to undergoing the same, or a similar, in-situ etch or clean as the susceptors between depositions (or after a number of depositions) when required. Thus, the thermal encapsulation rods may be formed of the same or similar materials as the susceptors.

And in embodiments where feedthroughs are established from the stationary bottom part of the flange, mobile electrical feedthroughs are not required.

In embodiments utilizing a vertical loading of the susceptors into the reactor, the susceptors may be hoisted down into the reaction chamber, thereby enclosing the encapsulated thermocouple rod. The thermocouple rod enclosure may provide reactor gas access to the enclosed thermocouple rod for purging, deposition, and etch. In another embodiment, the encapsulated thermocouple rod may be supported in the upper region of the reactor by a quartz lobe that is part of an upper mobile flange lid of the reactor.

Embodiment variations relating to the designs shown in FIGS. 4 through 6, utilizing aspects of the non-contact temperature measurement and control innovations disclosed herein include: separating the upper reactor lid flange in an outer stationary part which allows for stationary electrical feedthroughs and an inner mobile upper reactor lid flange that enables susceptor loading and unloading; and, designing the electrical feedthroughs to the thermocouples as part of the mobile upper reactor lid flange wherein the encapsulated thermocouples are suspended from above (and optionally enclosed by susceptor halves and arranged at the edges of said susceptor halves).

In operation, the disclosed subject matter provides a non-invasive and non-contact method for the temperature calibration and control of a confined reactor chamber providing an accurate reading of the susceptor and workpiece temperature within the chamber. In the reactor embodiments disclosed, a face to face susceptor arrangement provides a substantially uniform temperature distribution in width of the cavity between the facing susceptors. Thus, the thermocouple assembly may be deployed to calibrate and control the deposition process temperatures using thermocouples positioned to form a one or two dimensional temperature measurement map.

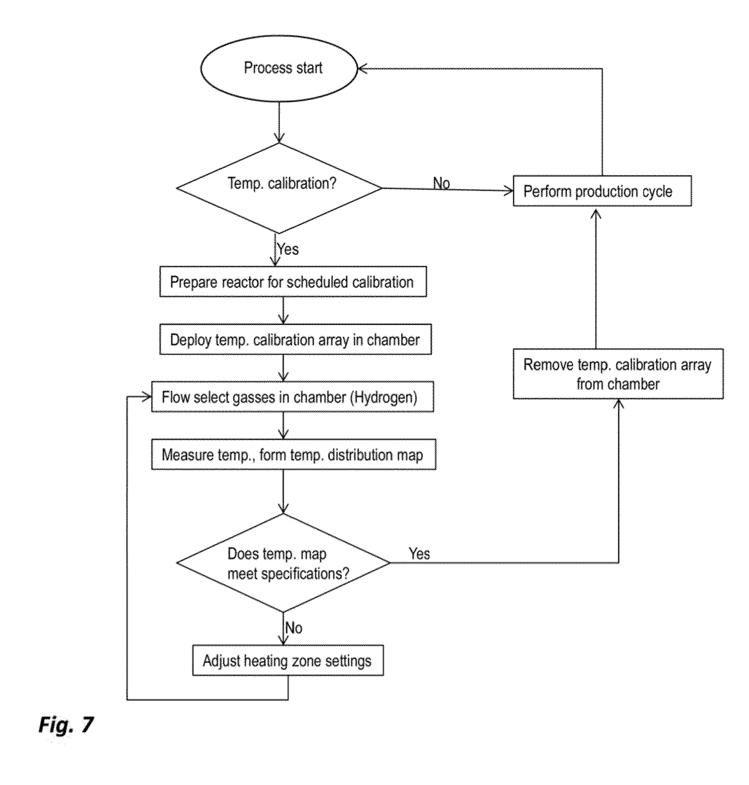

FIG. 7 is a general process flow showing a non-invasive high throughput temperature calibration method in accordance with the disclose subject matter. Before a thermal reactor process cycle begins, after a predetermined number of cycles or based on any number of inputs such as deposition uniformity or chamber temperature, if a temperature calibration is needed a thermocouple assembly is deployed into process environment defined by the cavity between the face to face susceptors in the reactor. Select processing gasses are flowed to mimic a production cycle (for example hydrogen in the case of a deposition or annealing gasses in the case of an anneal process). The thermocouples collect temperature measurements which are then processed by control software and a two-dimensional map of the cavity temperature during processing is formed. Based on the two dimensional map, the workpiece temperature may be determined and the heating source (such as heat lamps) adjusted for certain heat zones which may outside of specifications. A key feature of the disclosed subject matter is the ability to collect temperature data among a number of heat zones corresponding to a heat source which may be adjusted to control the temperature of the heat zones—and thus manage and control the temperature of the chamber cavity to improve processing. In the face to face susceptor arrangement shown, the thermocouple assembly may be a two-dimensional thermocouple array (thermocouples positioned in the h′ and z-axis, as shown in FIG. 3B, directions) directions for forming a two-dimensional temperature map. The temperature gradient between the susceptors, along the w′ axis, may be substantially negligible. After the heating zones have been adjusted to be within pre-determined requirements, the non-contact thermocouple assembly is removed from the chamber and production cycles may be performed.

The foregoing description of the exemplary embodiments is provided to enable any person skilled in the art to make or use the claimed subject matter. Various modifications to these embodiments will be readily apparent to those skilled in the art, and the generic principles defined herein may be applied to other embodiments without the use of the innovative faculty. Thus, the claimed subject matter is not intended to be limited to the embodiments shown herein but is to be accorded the widest scope consistent with the principles and novel features disclosed herein. Further, it is intended that all such additional systems, methods, features, and advantages that are included within this description be within the scope of the claims.

What is claimed is:

1. A thermal processing system, comprising:
a chamber housing a pair of susceptors positioned in a face to face arrangement, each of said susceptors having a wafer pocket for supporting a wafer, said pair of susceptors forming a processing cavity between said wafers;
a heating source heating said susceptors and forming a thermal equilibrium in said processing cavity; and
a thermocouple assembly comprising an encapsulation rod, said encapsulation rods housing at least one thermocouple, said thermocouple positioned to measure the susceptor temperature of said susceptor surface proximate said processing cavity.

2. The thermal processing system of claim 1, wherein said thermocouple assembly may be deployed and removed from said cavity for the calibration of said susceptor temperature without susceptor contact.

3. The thermal processing system of claim 1, further comprising a plurality of encapsulation rods arranged in an array.

4. The thermal processing system of claim 1, further comprising:
a monolithic thermocouple encapsulation portion, said thermocouple encapsulation portion enclosing said thermocouple assembly outside of said processing cavity;
a thermocouple feed through providing measurement data from said thermocouple assembly during thermal processing.

5. The thermal processing system of claim 1, wherein said thermocouple assembly is made of a susceptor like material and positioned in said processing cavity.
